(19) United States
(12) Patent Application Publication
(10) Pub. No.: US 2025/0006899 A1
(43) Pub. Date: Jan. 2, 2025

(54) ANODE VOID SPACE BURNOUT FOR HIGH-CONTENT SILICON CARBON ANODES FOR LITHIUM-ION BATTERIES

(71) Applicant: GM GLOBAL TECHNOLOGY OPERATIONS LLC, Detroit, MI (US)

(72) Inventor: Julia Ruth Klein, Columbus, OH (US)

(73) Assignee: GM GLOBAL TECHNOLOGY OPERATIONS LLC, Detroit, MI (US)

(21) Appl. No.: 18/343,042

(22) Filed: Jun. 28, 2023

(51) Int. Cl. H01M 4/36; H01M 4/04; H01M 4/133; H01M 4/134; H01M 4/38; H01M 4/587

(52) U.S. Cl. CPC H01M 4/366; H01M 4/0404; H01M 4/045; H01M 4/133; H01M 4/134; H01M 4/386; H01M 4/587; H01M 2004/027

(57) ABSTRACT

An anode electrode for use in a lithium-ion battery cell including silicon and a porous carbonaceous anode electrode coating is provided. The anode electrode includes an electrode substrate including a current collector and the porous carbonaceous anode electrode coating. The electrode coating includes a surface material including graphite, wherein the surface material includes a plurality of sphere-shaped depressions, carbon particles, and a plurality of silicon particles affixed to inner walls of the plurality of sphere-shaped depressions. The sphere-shaped depressions are configured for receiving expansion of the plurality of silicon particles when the silicon particles are in a lithiated state.

### BACKGROUND

The present disclosure relates to an anode electrode including a porous electrode coating, wherein the porous electrode coating enables expanding silicon particles to expand into the pores, and a method of fabricating the same.

Electrochemical energy storage devices, such as lithium-ion batteries, may be used to power such diverse items as toys, consumer electronics, and motor vehicles. Typically, a battery includes two electrodes, as well as an electrolyte component and/or a separator. One of the two electrodes generally serves as a positive electrode or cathode, and the other electrode serves as a negative electrode or anode. Electrochemical battery cells may be broadly classified into primary and secondary batteries. Primary batteries, also referred to as disposable batteries. are intended to be used until depleted, after which they are simply replaced with new batteries. Secondary batteries, more commonly referred to as rechargeable batteries, employ specific chemistries permitting such batteries to be repeatedly recharged and reused.

Rechargeable batteries may be in a solid form, a liquid form, or a solid-liquid hybrid. A separator and/or electrolyte may be disposed between the negative and positive electrodes. In rechargeable lithium-ion batteries, the electrolyte is typically employed for conducting lithium ions between the electrodes. Generally, lithium-ion batteries operate by reversibly passing lithium ions back and forth between the negative electrode and the positive electrode. For example, lithium ions may move from the positive electrode to the negative electrode during charging of the battery and in the opposite direction when the battery is discharging. Ability of battery electrodes to repeatedly insert into their respective structures and extract therefrom lithium ions is determinative of practical long-term charging capacity of the battery cell.

Energy density describes how much energy a battery contains in proportion to a weight of the battery. Higher energy density reflects a higher capacity of the battery to deliver energy.

### SUMMARY

An anode electrode for use in a lithium-ion battery cell including silicon and a porous carbonaceous anode electrode coating is provided. The anode electrode includes an electrode substrate including a current collector and the porous carbonaceous anode electrode coating. The electrode coating includes a surface material including graphite, wherein the surface material includes a plurality of sphere-shaped depressions, carbon particles, and a plurality of silicon particles affixed to inner walls of the plurality of sphere-shaped depressions. The sphere-shaped depressions are configured for receiving expansion of the plurality of silicon particles when the silicon particles are in a lithiated state.

In some embodiments, each of the plurality of sphere-shaped depressions includes a portion of the plurality of silicon particles. When the plurality of silicon particles is in an unlithiated state, each of the plurality of sphere-shaped depressions includes an internal volume of at least three times the volume of the silicon particles in the unlithiated state.

In some embodiments, each of the plurality of silicon particles is permanently bonded to the inner walls of the plurality of sphere-shaped depressions, such that the plurality of silicon particles remains in conductive contact with the surface material through the lithiated state and the unlithiated state.

In some embodiments, the porous carbonaceous anode electrode coating is doped with nitrogen, phosphorus, silver, tin, lithium alloying materials, or conductive atoms to anchor the silicon to the surface material.

In some embodiments, when the plurality of silicon particles is in the lithiated state, the anode electrode expands in volume by at least 5% as compared to a volume of the anode electrode when the plurality of silicon particles is in the unlithiated state.

According to one alternative embodiment, a battery cell including an anode electrode for use in a lithium-ion battery cell including silicon and a porous carbonaceous anode electrode coating is provided. The battery cell includes the anode electrode. The anode electrode includes an electrode substrate including a current collector and the porous carbonaceous anode electrode coating. The electrode coating includes a surface material including graphite. The surface material includes a plurality of sphere-shaped depressions, carbon particles, and a plurality of silicon particles affixed to inner walls of the plurality of sphere-shaped depressions. The sphere-shaped depressions are configured for receiving expansion of the plurality of silicon particles when the silicon particles are in a lithiated state. The battery cell further includes a cathode electrode and an electrolyte.

In some embodiments, each of the plurality of sphere-shaped depressions includes a portion of the plurality of silicon particles. When the plurality of silicon particles is in an unlithiated state, each of the plurality of sphere-shaped depressions includes an internal volume of at least three times the volume of the silicon particles in the unlithiated state.

In some embodiments, each of the plurality of silicon particles is permanently bonded to the inner walls of the plurality of sphere-shaped depressions, such that the plurality of silicon particles remain in conductive contact with the surface material through the lithiated state and the unlithiated state.

In some embodiments, the porous carbonaceous anode electrode coating is doped with nitrogen, phosphorus, silver, tin, or other lithium alloying materials, or conductive atoms to anchor the silicon to the surface material.

According to one alternative embodiment, a method to manufacture an anode electrode for use in a lithium-ion battery cell including silicon and a porous carbonaceous anode electrode coating is provided. The method includes affixing a plurality of silicon particles to each of a plurality of low temperature burnout particles configured for evaporating as a result of a burnout process. The method further includes creating a mixture. The mixture includes the plurality of low temperature burnout particles, each including the plurality of the silicon particles, a polymer material configured for creating electrically conductive graphite as a result of the burnout process, and carbon particles. The method further includes applying the mixture to an electrode substrate as a plurality of active material particles and operating the burnout process upon the plurality of active material particles. The burnout process converts the polymer material into the graphite to form an electrically conductive surface material of the plurality of active material particles and vaporizes the plurality of low temperature burnout particles, thereby leaving a plurality of sphere-shaped depressions in the surface material, one of the plurality of sphere-shaped depressions for each of the plurality of low temperature burnout particles. The burnout process further results in the plurality of silicon particles being affixed to inner walls of the plurality of sphere-shaped depressions. The sphere-shaped depressions are configured for receiving expansion of the plurality of silicon particles when the silicon particles are in a lithiated state.

In some embodiments, affixing the plurality of silicon particles to each of the plurality of low temperature burnout particles configured for evaporating as a result of the burnout process includes affixing the plurality of silicon particles to a plurality of polystyrene foam balls.

In some embodiments, the method further includes selecting the plurality of low temperature burnout particles configured for evaporating as a result of the burnout process in a size range configured such that a volume of the low temperature burnout particles configured for evaporating as a result of the burnout process is at least three times the volume of the silicon particles in an unlithiated state.

In some embodiments, affixing the plurality of silicon particles to each of the plurality of low temperature burnout particles configured for evaporating as a result of the burnout process includes rolling the plurality of low temperature burnout particles configured for evaporating as a result of the burnout process in a silicon dust.

In some embodiments, applying the mixture to the electrode substrate includes applying the mixture as a slurry.

In some embodiments, applying the mixture to the electrode substrate includes applying the mixture through an electrodepositing process.

In some embodiments, applying the mixture to the electrode substrate includes utilizing a vacuum drum device upon the electrode substrate to achieve a desirable dispersion of the active material particles upon the electrode substrate and to remove excess active material particles.

In some embodiments, the method further includes doping the mixture with nitrogen, phosphorus, silver, tin, or lithium alloying atoms all to anchor the silicon particles to the inner walls.

In some embodiments, the method further includes adding to the mixture a binder, carbon black, or carbon nanotubes.

The above features and advantages and other features and advantages of the present disclosure are readily apparent from the following detailed description of the best modes for carrying out the disclosure when taken in connection with the accompanying drawings.

### BRIEF DESCRIPTION OF DRAWINGS

FIG. 1 is a schematic view of an electrical energy storage cell powering a load, the energy storage cell being shown as a lithium-ion (Li-Ion) battery relative to three-dimensional (X-Y-Z) space, having respective positive and negative cell electrodes, in accordance with the present disclosure;

FIG. 2A is a schematic close-up cross-sectional side view of a representative electrode, shown in FIG. 1, having a current collector fixed to an electrode substrate, wherein the current collector has a three-dimensional (three-dimensional) porous structure, in accordance with the present disclosure;

FIG. 2B is a schematic close-up cross-sectional side view of a base, prior to various coating layers, current collector for the electrode shown in FIG. 2A, illustrated as having variable porosity, in accordance with the present disclosure;

FIG. 3A is a schematic close-up cross-sectional side view of an alternative representative electrode, shown in FIG. 1, having a current collector fixed to an electrode substrate, wherein the current collector has a three-dimensional (three-dimensional) porous structure, in accordance with the present disclosure;

FIG. 3B is a schematic close-up cross-sectional side view of a base, prior to various coating layers, current collector for the electrode shown in FIG. 3A, illustrated as having constant porosity, in accordance with the present disclosure;

FIG. 4A is a schematic close-up top view of the three-dimensional porous structure coated with an interface layer, as well as with a conductivity additive and/or a polymer binder, and with active material particles embedded within the porous structure, in accordance with the present disclosure;

FIG. 4B is a schematic close-up top view of the three-dimensional porous structure coated with an interface layer, as well as with a conductivity additive and/or a polymer binder, and without active material particles embedded within the porous structure, in accordance with the present disclosure;

FIG. 5 schematically illustrates an exemplary surface of active material particles from FIGS. 1, 3A, and 4A, in accordance with the present disclosure;

FIG. 6 schematically illustrates one of the pores of FIG. 5 in cross-section. The surface material of the active material particle is illustrated, in accordance with the present disclosure;

FIG. 7 schematically illustrates the pore of FIG. 6, wherein the silicon particles of FIG. 6 have transitioned into lithiated silicon particles, in accordance with the present disclosure;

FIG. 8 schematically illustrates the active material particle during a manufacture process, prior to a burnout event being performed upon the active material particle, in accordance with the present disclosure;

FIG. 9 is a flowchart illustrating a first exemplary method to manufacture the disclosed active material particles and the corresponding anode electrode coating, in accordance with the present disclosure;

FIG. 10 is a flowchart illustrating a second exemplary method to manufacture the disclosed active material particles and the corresponding anode electrode coating, in accordance with the present disclosure; and

FIG. 11 illustrates an alternative exemplary process to create an anode electrode, in accordance with the present disclosure.

### DETAILED DESCRIPTION

Energy density describes how much energy a battery contains in proportion to a weight of the battery. Higher energy density reflects a higher capacity of the battery to deliver energy. A battery cell includes an anode and a cathode. The cathode may be described as a cathode electrode. The anode or the anode electrode includes a current collector, frequently a conductive film, for example, constructed with copper, and an anode electrode coating. The current collector of the anode may be a three-dimensional current collector such as a three-dimensional mesh, with complex surfaces useful for increasing a surface area of the current collector, as described herein. The cathode includes a current collector and a cathode electrode coating. The anode electrode coating may include an anode active material coating, a binder, and a conductive material. The cathode electrode coating may include a cathode active material coating, a binder. and a conductive material. Chemistry of the anode active material and the cathode active material are utilized to generate and control the electrochemical reaction that takes place in the battery cell.

Particular materials are useful to increase energy density of the battery cell. Silicon is useful within the anode active material for increasing energy density of the battery cell. During a battery cell discharge cycle, lithium ions move from the active material coating of the anode electrode to the active material coating of the cathode electrode. During a battery cell charging cycle, lithium ions move from the cathode electrode coating to the anode electrode coating. Silicon particles change in size significantly in the presence of lithium. While not in the presence of lithium. the silicon particles are relatively small. While in the presence of lithium, silicon particles swell or expand greatly. The silicon of an anode electrode may increase in size by 300% in the presence of lithium. The anode electrode will increase in volume proportionally to the amount of silicon in the anode electrode coating mixture. Such gross outward expansion of an anode electrode coating rapidly causes cracking and failure of the anode electrode coating.

An anode electrode coating and a method for making the same are provided, wherein the anode electrode coating includes active material particles which are porous and include silicon particles secured to inner surfaces of pores, such that, when exposed to lithium, the silicon particles expand into the voids of the pores. This expansion of the silicon particles into the voids of the pores of the anode electrode coating enables the silicon particles to expand without significantly changing the overall size of the anode electrode coating. In one embodiment, the disclosed electrode may be configured for expansion due to silicon lithiation in a range from a 3% increase in electrode volume to a 5% increase in electrode volume as compared to an electrode with unlithiated silicon. In another embodiment, the disclosed electrode may be configured for expansion due to silicon lithiation with an up to 10% increase in electrode volume as compared to an electrode with unlithiated silicon. In this way, silicon loading or an amount of silicon present on an anode electrode coating may be increased, thereby increasing energy density of the anode, without causing damage to the anode electrode coating.

According to one exemplary method to manufacture the disclosed active material particles, one may make a small ball of polymer with a low temperature of volatilization, e.g., polystyrene foam. In other exemplary embodiments, the polymer ball may be constructed with cellulose acetate, polyethylene, polybutylene, or polypropylene. This polymer ball may be selected or configured for evaporating at temperatures utilized in a selected burnout process. One may select or ensure the size of the polymer ball is approximately or at least three times the size of the unlithiated silicon that will be added to it. One may further coat the outside of the polymer ball with silicon nano particles of appropriate size for use in lithium-ion batteries. One may further select or ensure the total silicon amount adhered to the polymer ball, with the silicon in an unlithiated state, is approximately one third the volume of the polymer ball. In an optional step, one may coat the polymer ball with the silicon adhered to the polymer ball, i.e., the compound ball, with a binder, adhesive, carbon, or polymer material. This outer polymer material or polymer material that surrounds the polymer balls prior to the burnout process may be a second polymer type as compared to the polymerized ball and may be selected or configured for carbonizing or transforming into electrically conductive graphite at temperatures utilized in the selected burnout process. The polymerized ball is configured for evaporating during the burnout process, and the polymerized material is configured for transforming into electrically conductive graphite during the burnout process. One may further mix the outer polymer material with anode materials, including carbon particles, one or more binders, carbon black, carbon nanotube additives, and/or other ingredients utilized in lithium-ion battery anodes in the art.

The compound ball may, in an optional step, be coated with an additive or the carbon material and may be mixed with an additive to dope the carbonized polymer material with nitrogen, phosphorus, silver, tin, lithium alloying materials, conductive atoms, or another appropriate material for the purpose of bonding with or alloying to the silicon to hold it in place in the walls of the void space. The bond can be between the extra lone pair of electrons in the dopant, such as in nitrogen or phosphorus, or from an ionic or covalent bond by alloying metals.

Further, one may bake the anode and burnout/carbonize the polymer ball and the polymer material. One may dry the wet anode at low temperature. One may further burnout the polymer ball at medium temperature to create the void space for the silicon nano particles embedded into the polymer walls of the void space. In an alternative operation, the polymer ball that is used to create the void space may be placed in a “vacuum oven”, the pressure within the oven may be lowered, and relatively lower temperatures may be utilized to evaporate the polymer ball. One may additionally carbonize the polymer material into graphite carbon appropriate for use in a lithium-ion battery anode. As a result of the burnout process, wherein the polymer balls are evaporated and the outer polymer material is carbonized into graphite, the silicon nano particles are embedded into electrically conductive graphite walls of the void space. The silicon will maintain high electrical conductivity at all states of charge. The void space is sized to fully accommodate the expansion of the silicon as it charges, lithiates and experiences volumetric expansion of approximately 300% as compared to the silicon in an unlithiated state.

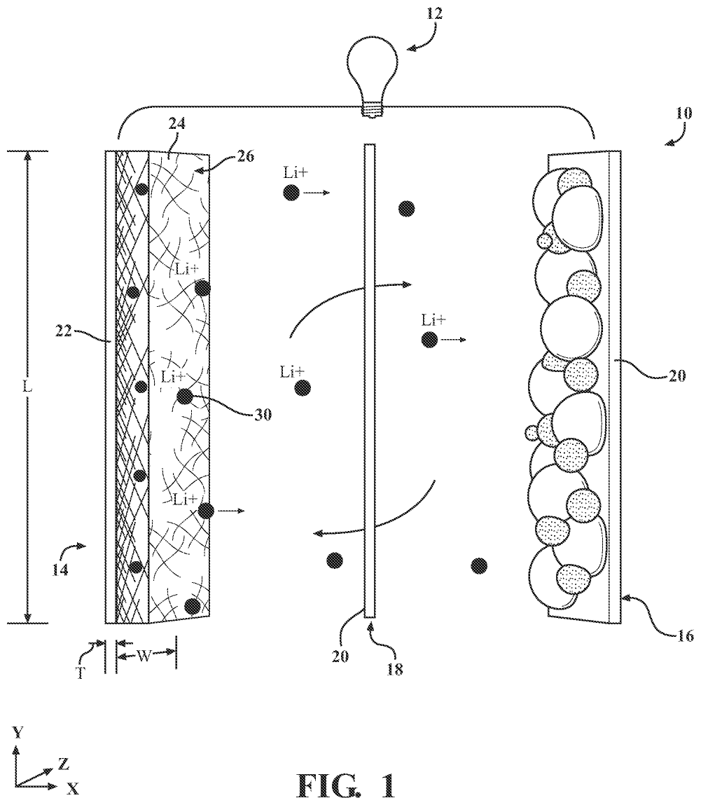

FIG. 1 schematically illustrates in side view an electrical energy storage cell powering a load, the energy storage cell being shown as a lithium-ion (Li-Ion) battery relative to three-dimensional (X-Y-Z) space, having respective positive and negative cell electrodes. An electrical energy storage cell 10 powering a load 12 is illustrated. As shown, the electrical energy storage cell 10 has an anode (negative electrode) 14, a cathode (positive electrode) 16, and one of a solid, liquid, gel, or polymer non-aqueous, e.g., polymer-based, electrolyte 18 surrounding the anode, cathode, and saturating a separator diaphragm 20. The storage cell 10 is specifically shown as a lithium-ion (Li-Ion) battery. The anode 14 may include a three-dimensional mesh current collector and may be constructed from lithium, graphite, silicon, silicon oxide and various other suitable material. While the cathode 16 is frequently constructed from Li ion battery cathode material, such as lithium manganese oxide, lithium iron phosphate, lithium nickel/manganese/cobalt oxide, or a variety of other suitable materials, may also be used.

Li-Ion batteries are rechargeable electrochemical batteries notable for their high specific energy and low self-discharge. The Li-Ion batteries may be used to power such diverse items as toys, consumer electronics. and motor vehicles. Although the electrical energy storage cell 10 is specifically shown as a Li-Ion battery. broadly considered, other battery chemistries and corresponding structures are also envisioned. The subject vehicle may include, but not be limited to, a commercial vehicle. industrial vehicle, passenger vehicle, aircraft, watercraft. train or the like. It is also contemplated that the vehicle may be a mobile platform, such as an airplane. all-terrain vehicle (ATV). boat, personal movement apparatus, robot and the like to accomplish the purposes of the present disclosure.

In Li-Ion batteries, lithium ions move from the anode 14 through the electrolyte 18 to the cathode 16 during discharge, and back when charging. Li-Ion batteries use a lithium metal oxide, such as Li-NMC, Li-NMCA, LMO, NMO, LFP etc., as the material at the positive electrode and typically graphite at the negative electrode. Generally, the reactants in the electrochemical reactions in a Li-Ion cell 10 are materials of anode and cathode, both of which are compounds that may host lithium atoms. During discharge, an oxidation half-reaction at the anode 14 produces positively charged lithium ions and negatively charged electrons. Lithium ions move through the electrolyte 18, electrons move through an external circuit (including a connection to the electrical load 12 or to a charging device), and then they recombine at the cathode (together with the cathode material) in a reduction half-reaction.

The electrolyte 18 and the external circuit provide conductive media for lithium ions and electrons, respectively, but do not partake in the electrochemical reaction. Generally, during discharge of an electrochemical battery cell, electrons flow between the electrodes, from the anode 14 toward the cathode 16, through the external circuit. The reactions during discharge lower the chemical potential of the cell, so discharging transfers energy from the cell to wherever the electric current dissipates its energy, mostly in the external circuit. During charging, the described reactions and transports go in the opposite direction: electrons move from the positive electrode to the negative electrode through the external circuit. To charge the cell, the external circuit has to provide electric energy. This energy is then stored (with some loss) as chemical energy in the cell.

In a Li-Ion cell, both the anode 14 and cathode 16 allow lithium ions to move in and out of their structures via a process called insertion (intercalation) or extraction (deintercalation), respectively. Typically, the anode 14 employs a current collector, which may be manufactured from copper and includes an active layer configured to intercalate lithium ions. Generally, the amount of lithium held by the active layer is directly related to the performance of a Li-Ion battery. Furthermore, the capacity of the active layer to intercalate lithium is limited by its physical or the material's molecular structure. Accordingly, an increase in the amount of lithium held by the electrode, such as the anode 14, would be beneficial to the performance, e.g., cycling capacity, of a Li-Ion battery cell 10.

A specific construction of the electrode for a lithium-ion battery cell 10, such as the anode 14 (or the cathode 16), is configured to maximize an amount of lithium held thereby during charging and discharging. Particularly in the case of an anode, during charging lithium bonds to silicon, which leads to significant swelling of the silicon. The subject construction of the electrode, to be described in detail below, is specifically configured to accommodate the silicon swelling during charging and also permit transport of lithium ions in and out of the electrode structure following the swelling. The subject electrode includes an electrode substrate 22, which may be constructed from a section of metal foil (generally identified as a current collector foil) defined by thickness T, a width W, and a length L. The electrode may also include a current collector 24 fixed to, such as adhered or formed on, the electrode substrate 22. In one embodiment, the current collector 24 may be a flat sheet of flexible foil that may have slurry painted on the foil in a roll-to-roll operation. The foil may include structure added on top of the foil to create the three-dimensional structure described herein. The current collector 24 may be fixed to the electrode substrate 22 by a process of electroplating, electrochemical deposition, physical deposition, or welding. Specifically, material of the current collector 24 may be electrochemically deposited onto a surface of the electrode substrate 22 to generate the subject battery cell 10 electrode. Each of the electrode substrate 22 the current collector 24 may be composed of or constructed from copper.

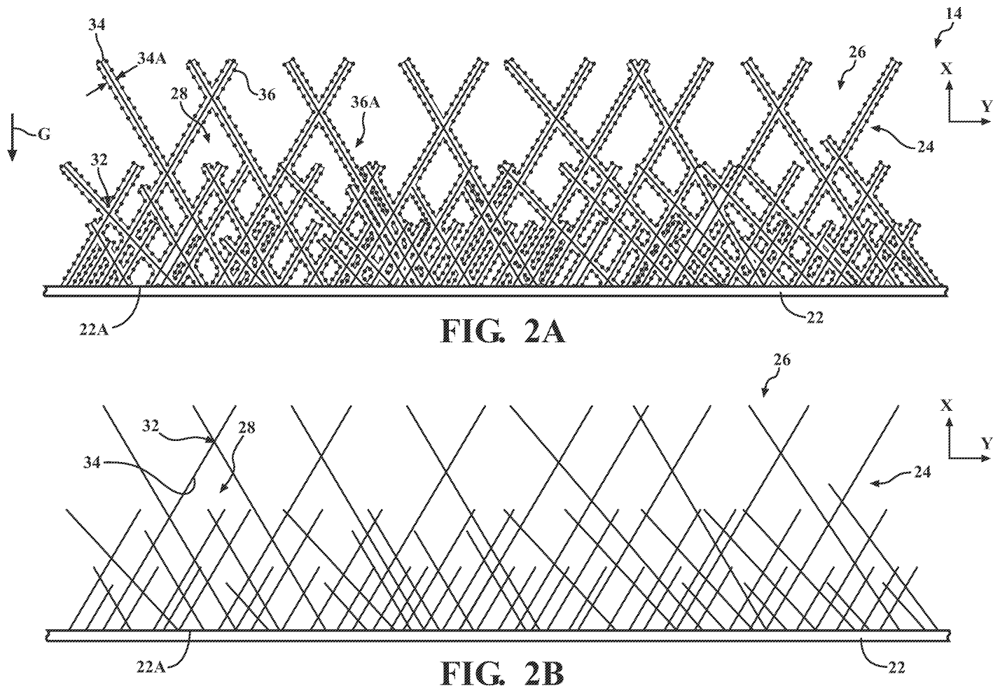

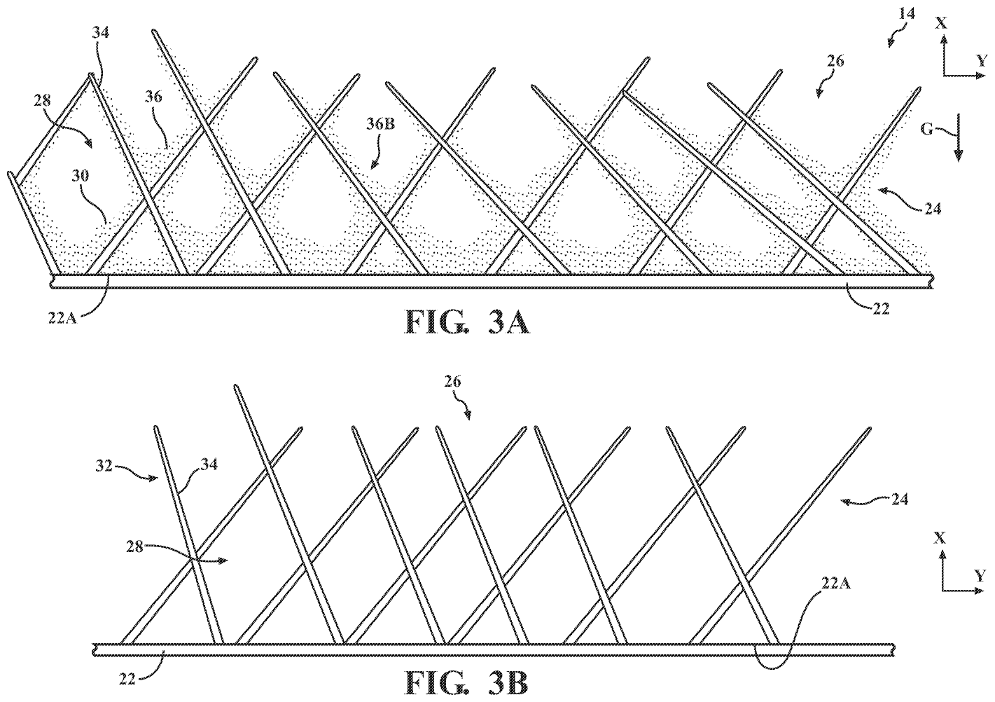

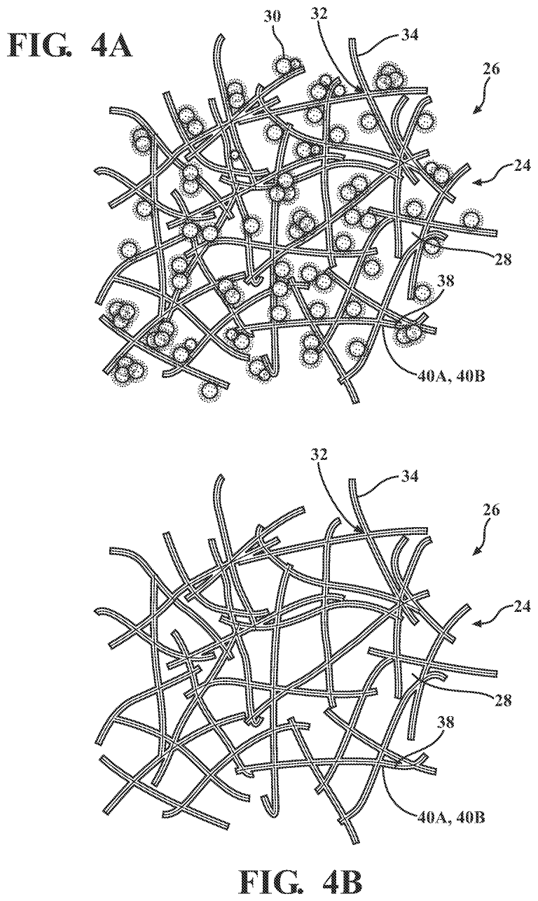

As shown in FIGS. 2-4B, the resultant current collector 24 applied onto the electrode substrate 22 has a three-dimensional (three-dimensional) porous structure 26 defining multiple interstitial void spaces 28 (shown in FIGS. 3-4B) generated, for example, by contacting, crisscrossing, and/or interwoven fibers. The current collector 24 may, for example, and as shown in FIG. 1, provide an anode 14 structure. The void spaces 28 are configured to accommodate therein active material particles 30, e.g., of a lithium-alloy material. Additionally, prior to initial charging of the battery cell 10, the void spaces 28 may be prefilled and/or covered with the polymer, gel, or glass/ceramic electrolyte 18. Specifically, while the void spaces 28 are generally left open and not filled, they may be prefilled with a gel or soft polymer electrolyte 18. Additionally, a top surface of the current collector 24 may be covered with a polymer or solid glass/ceramic electrolyte 18 to seal the subject surface of the current collector relative to the separator 20.

The term “three-dimensional porous” is herein used to indicate a current collector structure that includes porosity having a varying or uneven size in three-dimensional space, such as in a direction orthogonal to a mounting surface 22A of the electrode substrate 22. The three-dimensional porous structure 26 may also be designated as “porosity-controlled”, which herein denotes a collector body having a particularly defined distribution of variable porosity and non-uniform magnitude of included pores. A specific distribution of variable porosity in the three-dimensional porous structure 26 is intended to facilitate effective internal rather than external expansion volume of the intercalated active material particles 30 attached to the current collector 24 during charging of the battery cell 10.

As shown in FIG. 2, the three-dimensional porous structure 26 may include nodes 32 established by pore walls 34. The pore walls 34 define the void spaces 28. The three-dimensional porous structure 26 may further have a variable size porosity, i.e., the void spaces 28 may have a variable size. The three-dimensional porous structure 26 may be further characterized by a porosity gradient G defined by the pore walls 34 gradually increasing in thickness 34A with greater proximity to the electrode substrate 22. An electrodeposited attachment layer or vapor deposition attachment may be added to fibers initially unconnected to each other, thereby generating intersectional nodes 32. The nodes 32 may also increase in thickness with greater proximity to the mounting surface 22A of the electrode substrate 22 to carry higher electrical current. Accordingly, the subject gradient G may be purposefully configured to support comparatively higher energy density loading during charging of the battery cell 10 on the current collector 24 proximate the electrode substrate 22 (relative to density loading closer to the outer surface of the current collector).

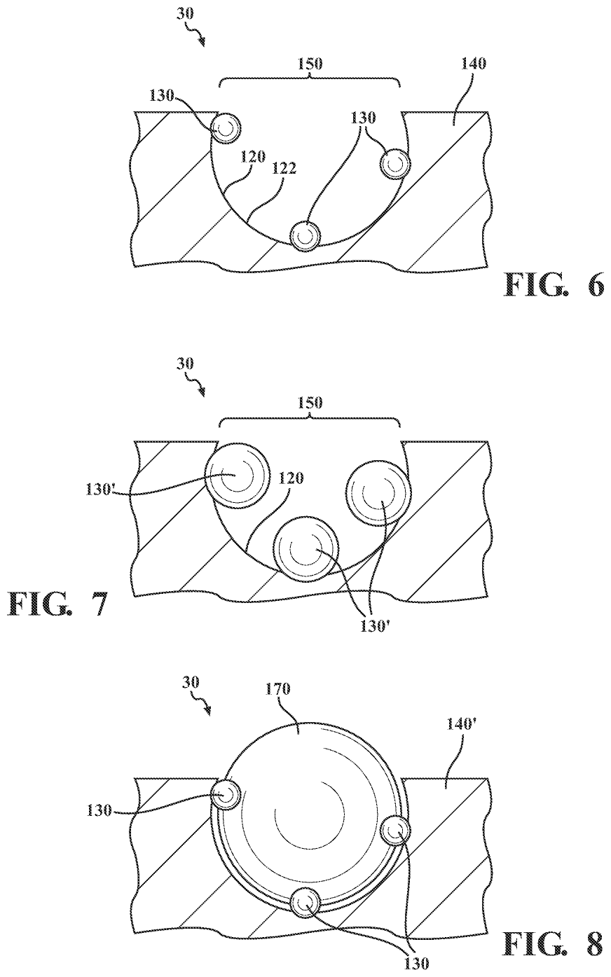

The pore walls 34 may include a coating 36 applied thereto. The coating 36 may be applied via polymer coating or particle coating and in certain embodiments be configured to generate the gradient G. Polymer coating and particle coating may be applied by a variety of options, shown in exemplary fashion in FIGS. 6A-6E, such as dip coating and drum drying, spray coating, slurry coating with a slot die, roll coating in wet/dry particle bed, fluidized air particle bed, thermal (vapor) deposition, vacuum drum coating and drying (filtration). Specifically, the coating 36 may include one or more layers of a binder or adhesive configured to affix the active material particles 30 to the pore walls 34. As shown in FIG. 2A, the coating 36 may have a constant thickness 36A in an embodiment where porosity of the base current collector 24 is variable (shown in FIG. 2B). Alternatively, as shown in FIG. 3A, the coating 36 may have a varying thickness 36B in an embodiment where porosity of the base current collector 24 is constant (shown in FIG. 3B). Accordingly, as may be seen in FIGS. 2A and 3A, in either embodiment, the resultant three-dimensional porous structure 26 will have the size of the void spaces 28 progressively increasing with further distance from the electrode substrate 22, thereby defining the gradient G.

The active material particles 30 will be applied to the three-dimensional porous structure 26 as a coating, such that the active material particles become arranged and dispersed within the void spaces 28 of the three-dimensional porous structure. As a result, charging of the battery cell 10 employing the subject electrode reversibly deposits transient (such as lithium) ions onto the active material particles 30 and expands (or swells) the active material particles into the void spaces 28 of the three-dimensional porous structure 26, thereby generating an interstitial active material current collector structure. On the other hand, discharging the battery cell 10 employing the subject electrode extracts the transient ions from the active material particles 30, such that the active material contracts out of the void spaces 28 of the three-dimensional porous structure 26. Accordingly, the battery cell 10 may undergo repeated cycles of intercalation and deintercalation of lithium ions in the process of accepting charge from an external energy source, such as electrical grid, and then supply the charge to power the load 12.

Each of FIGS. 4A and 4B depict a top view of the three-dimensional porous structure 26, respectively with and without the active material particles 30 embedded therein. As shown in FIGS. 4A and 4B, the current collector 24 may be coated with an interface layer 38 configured to attract and/or attach to the active material particles 30. Additionally, the current collector 24 may be coated with a conductivity additive 40A and/or an elastic polymer binder 40B. In the embodiment where the current collector 24 is coated with the polymer binder 40B, the binder may then be cured, polymerized, carbonized and/or graphitized, such as in a vacuum, an oven, and/or with infrared or ultraviolet light. The current collector 24 may be pre-coated with the active material particles 30. In such an embodiment, the pre-coat active material particles 30 may be provided either in wet carbon-silicon electrode slurry, solid particles, a polymer coating mixed with silicon particles, or a solid lithium form. The pre-coat may be employed to “prelithiate”, i.e., effectively pre-charge, the lithium-ion battery anode 14 and mitigate non-recoverable loss of lithium during initial cycling of the battery cell 10 and increase overall cycle capacity of the battery cell.

The electrode embodying the three-dimensional porous structure 26 may be subjected to a final cure to hold active material particles 30 in place, and also to evaporate low temperature material, such as from the carbon-silicon slurry. Manufacturing of the current collector 24 may also include removal of excess active material particles 30 from the current collector 24. Such removal of excess active material particles 30 may be accomplished by running the current collector 24 externally over a vacuum drum, via blowing through the three-dimensional porous structure 26 with a pressurized gas stream, or by agitating the current collector 24 on a vibration table. The completed current collector 24 is intended to provide the three-dimensional porous structure 26 capable of accommodating an increased volume of intercalated active material as compared to a current collector (with a similar external surface area) having consistently sized pores or a non-porous structure.

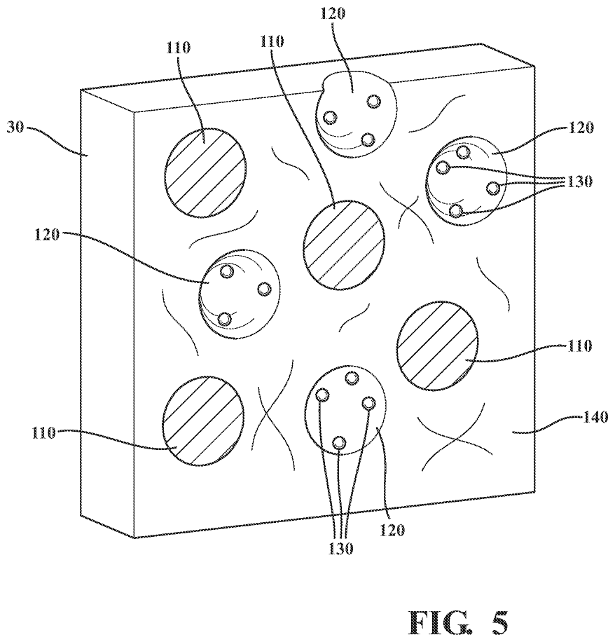

FIG. 5 schematically illustrates an exemplary surface of active material particles 30 from FIGS. 1, 3A, and 4A. For purposes of illustration, the components and structure of the surface of the active material particle 30 is illustrated as a flat surface. The surface of the active particle 30 may be curved, spherical, or irregular, and the illustrated surface of FIG. 5 is intended for non-limiting illustration only. Surface material 140 includes a polymerized binder material that is carbonized or burned out to form conductive carbon. Hard carbon particles 110 are illustrated interspersed within the surface material 140. Hard carbon particles 110 may alternatively be described as active anode carbons, such as mesocarbon particles. Pores 120 are illustrated including recesses formed in the surface material 140 and create porosity of the active material particle 30. Affixed, secured, or bonded to the walls of the pores 120 are a plurality of silicon particles 130. As described herein, the silicon particles 130 react with lithium ions and, when present, increase an energy density of the battery cell in which the anode electrode coating is disposed.

Electrode coatings utilized in the art may be porous such that an electrolyte or other material may interact with the coatings. The disclosed electrode coating may similarly include porosity configured for enabling interaction of the electrode coating with other materials. The disclosed electrode and method additionally and/or alternatively include porosity including the disclosed silicon materials embedded within the pores 120 to enable lithiation of the silicon particles 130 within the pores 120 which, in combinations with the three-dimensional current collector, enable controlled overall expansion of the corresponding electrode and increased silicon content.

The surface material 140 and the walls of the pores 120 include conductive carbon material. In one embodiment, the surface material 140 may be described as graphite.

FIG. 6 schematically illustrates one of the pores 120 of FIG. 5 in cross-section. The surface material 140 of the active material particle 30 is illustrated. The pore 120 may be described as a recess or a curved shape in the surface material 140 that creates a void space 150 in the surface material 140. The void space 150 may be described as a region into which liquid electrolyte of the battery cell may enter and into which lithium ions may flow. Silicon particles 130 are illustrated affixed to or embedded within a wall 122 of the pore 120. As the surface material 140 is carbonized and electrically conductive, the silicon particles 130 are in solid or permanent contact with the wall 122 and therefore have a strong electrically conductive contact with the surface material 140. The silicon particles 130 of FIG. 6 are illustrated in a non-lithiated state and are therefore at a relatively small size.

The silicon particles 130 may be embedded within the wall 122 of the pore 120 as part of the method to form the active material particles 30 as described herein. In one embodiment, the active material particle 30 may include the silicon particles 130 embedded in an outside layer of a hollow carbon sphere or sphere-shaped depression in the surface material 140, with the pore 120 forming the hollow space or a portion of the hollow space within the carbon body of the active material particle 30. In one embodiment, the active material particle may be doped with nitrogen, phosphorus, silver, tin, or other similar additives to anchor the silicon particles to the surface material 140.

FIG. 7 schematically illustrates the pore 120 of FIG. 6, wherein the silicon particles 130 of FIG. 6 have transitioned into lithiated silicon particles 130′. The lithiated silicon particles 130′ remain affixed to walls of the pore 120. The lithiated silicon particles 130′ are relatively larger than the silicon particles 130 of FIG. 6. In one embodiment, lithiated silicon particles 130′ of FIG. 7 may be 300% larger in volume than the unlithiated silicon particles 130 of FIG. 6. The void space 150 provides a volume into which the lithiated silicon particles 130′ may expand without changing an outside shape of the active material particle 30. In this way, silicon may be utilized within the active material particle 30 to increase the energy density of the battery cell without incurring the negative effects of the active material particles expanding wildly and causing the anode electrode coating to crack or fail. In one embodiment, the active material particle 30 may be configured for no external volume expansion. In another embodiment, the active material particle may be configured for minor or acceptable volume expansion (for example, permitting the active material particle to grow in size 5% by volume when the silicon particles 130 transition from an unlithiated state to a lithiated state.

FIG. 8 schematically illustrates the active material particle 30 during a manufacture process, prior to a burnout event being performed upon the active material particle. In one embodiment, the active material particle 30 in FIG. 8 represents a slurry particle, with a polymer material 140′ configured for creating electrically conductive graphite as a result of the burnout process. The polymer material 140′ may be in a liquid, paste, or colloidal state. A low-temperature burnout polymer particle 170 is illustrated within a recess in the polymer material 140′ configured for creating electrically conductive graphite as a result of the burnout process. The low temperature burnout particle 170 is selected based upon the material of the low temperature burnout particle 170 vaporizing within a temperature range of a burnout event. The low temperature burnout particle 170 may be described as a low temperature burnout particle configured for evaporating as a result of a burnout process. The low temperature burnout particle 170 may be constructed of polystyrene foam, for example, marketed as Styrofoam® which is commercially available through the DDP Specialty Electronic Materials US, Inc. Corporation of Wilmington, Delaware, United States. In other embodiments, similar low temperature polymer materials may be utilized. Prior to being disposed within the polymer material 140′, the low temperature burnout particle 170 may be rolled or disposed within a silicon dust or silicon particle bath. The silicon particles 130 adhere to or stick to the low temperature burnout particle 170, and the low temperature burnout particle 170 with the silicon particles 130 adhered thereto may be introduced to the polymer material 140′. The carbon particles 110 of FIG. 5 may additionally be introduced to the polymer material 140′. Upon completion of the burnout event, the low temperature burnout particle 170 is vaporized, the polymer material 140′ is carbonized, and the silicon particles 130 remain affixed within the pore 120 of FIG. 6 that is left when the low temperature burnout particle 170 is vaporized.

The disclosed active material particle 30 may have the silicon particles 130 embedded in the walls of the hollow sphere or sphere-shaped depression to maintain electrical contact at all times with the electrode. Smaller silicon particles can be used. A method for manufacturing the disclosed active material particle 30, the anode electrode coating employing the active material particle 30, or the battery cell utilizing the anode electrode coating employing the active material particle 30 is provided. The method uses binder burnout to create the hollow sphere or sphere-shaped depression of the void space. The method is well suited to use polymers that carbonize for the electrode carbon or the surface material 140. The size of the polymer burn-out ball, i.e., the low temperature burnout particle 170, may be approximately or at least three times the size of the unlithiated silicon is adhered to the polymer burn-out ball, in order to create three times the void space for the silicon particles 130 to expand during full lithiation. The silicon particles 130 may be described as nano particles. The nano particles are embedded into electrically conductive graphite walls of the void space. The silicon particles 130 will maintain high electrical conductivity with the connected surface material 140 at every state of charge. The void space may be sized to fully accommodate the expansion of the silicon particles 130 as they charge, lithiate, and experience volumetric expansion of approximately 300% as compared to the silicon particles 130 in their unlithiated state.

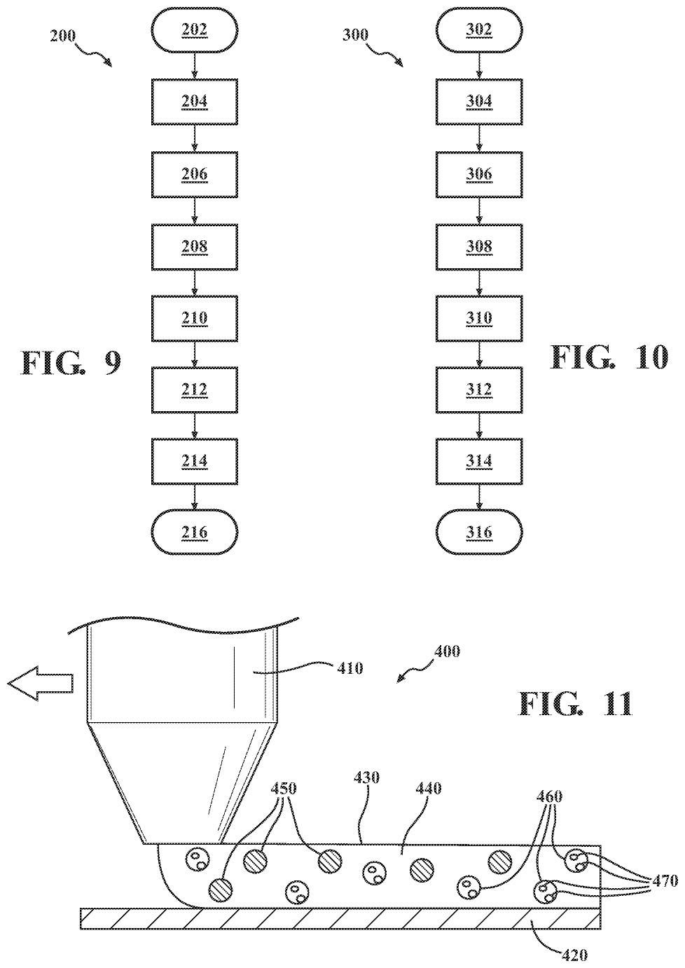

As is illustrated in FIG. 4A, the active material particles 30 may be applied to the three-dimensional porous structure 26 and/or the interface layer 38. The active material particles 30 may be prepared and applied according to a variety of alternative method steps. FIGS. 9 and 10 provide non-limiting examples of methods that may be utilized to prepare and apply the active material particles 30 and create the anode 14 of FIG. 1. The disclosed steps are exemplary, a number of alternative or additional method steps are envisioned, the disclosure is not intended to be limited to the examples provided.

Current collectors may have complex shapes, such as are illustrated in FIGS. 2A-3B. The disclosed methods may be utilized with other current collector configurations. FIG. 11 illustrates an alternative exemplary process 400 to create an electrode according to the disclosure. A current collector 420 including a metallic foil is illustrated. A dispenser mechanism 410 is illustrated connected to a premixed slurry. The dispenser mechanism 410 is illustrated dispensing electrode coating 430 upon the current collector 420. The electrode coating 430 is a slurry and includes a polymer material 440 configured for creating electrically conductive graphite as a result of a burnout process, a plurality of graphite particles 450, and a plurality of low temperature burnout particles 460 configured for evaporating as a result of the burnout process, each of the low temperature burnout particles 460 being coated with a plurality of silicon nanoparticles 470. Once the burnout process is performed upon the electrode coating 430, the polymer material 440 transforms into an electrically conductive graphite material and the low temperature burnout particles 460 evaporate, leaving the silicon nanoparticles 470 affixed to walls of pores in the surface of the electrode coating 430. A number of additional and/or alternative process steps are envisioned, and the disclosure is not intended to be limited to the examples provided herein.

FIG. 9 is a flowchart illustrating a first exemplary method 200 to manufacture the disclosed active material particles and the corresponding anode electrode coating. The method 200 is described in accordance with components described in the various FIGS. 1-8, while the method 200 may be operated with similar but distinct components. The method 200 starts at step 202. At step 204, a plurality of low temperature burnout particles configured for evaporating as a result of a burnout process 170, ex. Styrofoam balls, are preselected for a particular size based upon the silicon particles 130 and a total desirable silicon content that the resulting anode electrode coating is to include. These low temperature burnout particles configured for evaporating as a result of the burnout process 170 are immersed or rolled in a silicon dust or silicon particle bath, such that the low temperature burnout particles configured for evaporating as a result of the burnout process 170 include some of the silicon particles 130 affixed or stuck to the outside of the low temperature burnout particles configured for evaporating as a result of the burnout process 170. The step 204 may additionally include addition of additives or doping agents described herein. At step 206, these composite balls, the low temperature burnout particles configured for evaporating as a result of the burnout process 170 including affixed silicon particles 130, are added to a polymer material slurry, which may include carbon particles, binders, and other additives. At step 208, an electrode substrate is prepared or selected. The electrode substrate may include the three-dimensional porous structure 26 and/or the interface layer 38 of FIG. 4A. At step 210, the slurry mixture of step 206 is applied to the electrode substrate. A vacuum drum device or other similar device may be utilized to manipulate active material particle 30 positions and achieve a desirable active material particle 30 dispersion, as described in relation to FIGS. 2-3B. At step 212, a baking process is applied to burnout the low temperature burnout particles configured for evaporating as a result of the burnout process 170, thereby leaving a porous structure upon a surface of the active material particles 30, with the silicon particles 130 being affixed to inner walls of the pores 120. Further, the burnout process converts the polymer material of the slurry into the hardened and conductive surface material 140. At step 214, the coated electrode substrate is assembled to a battery cell and employed in operation of the battery cell. At step 216, the method 200 ends.

FIG. 10 is a flowchart illustrating a second exemplary method 300 to manufacture the disclosed active material particles and the corresponding anode electrode coating. The method 300 is described in accordance with components described in the various FIGS. 1-8, while the method 300 may be operated with similar but distinct components. The method 300 starts at step 302. At step 304, a plurality of low temperature burnout particles configured for evaporating as a result of the burnout process 170, ex. Styrofoam balls, are preselected for a particular size based upon the silicon particles 130 and a total desirable silicon content that the resulting anode electrode coating is to include. These low temperature burnout particles configured for evaporating as a result of the burnout process 170 are immersed or rolled in a silicon dust or silicon particle bath, such that the low temperature burnout particles configured for evaporating as a result of the burnout process 170 include some of the silicon particles 130 affixed or stuck to the outside of the low temperature burnout particles configured for evaporating as a result of the burnout process 170. The step 304 may additionally include addition of additives or doping agents described herein. At step 306, these composite balls, the low temperature burnout particles configured for evaporating as a result of the burnout process 170 including affixed silicon particles 130, are added to a polymer material mixture, which may include carbon particles, binders, and other additives. At step 308, an electrode substrate is prepared or selected. The electrode substrate may include a sheet of material in a roll-to-roll operation. The electrode substrate may receive or include the three-dimensional porous structure 26 which may be achieved through a copper electrodeposit process. The electrode substrate may additionally or alternatively receive the interface layer 38 of FIG. 4A. At step 310, the polymer material mixture of step 306 is applied to the electrode substrate through an electrodepositing process, wherein an electrical field is utilized to cause charged particles to adhere to the electrode substrate. A vacuum drum device or other similar device may be utilized to manipulate active material particle 30 positions and achieve a desirable active material particle 30 dispersion, as described in relation to FIGS. 2-3B. At step 312, a baking process is applied to burnout the low temperature burnout particles configured for evaporating as a result of the burnout process 170, thereby leaving a porous structure upon a surface of the active material particles 30, with the silicon particles 130 being affixed to inner walls of the pores 120. Further, the burnout process converts the polymer material of the slurry into the hardened and conductive surface material 140. At step 314, the coated electrode substrate is assembled to a battery cell and employed in operation of the battery cell. At step 316, the method 300 ends.

While the best modes for carrying out the disclosure have been described in detail, those familiar with the art to which this disclosure relates will recognize various alternative designs and embodiments for practicing the disclosure within the scope of the appended claims.

What is claimed is:

1. An anode electrode for use in a lithium-ion battery cell including silicon and a porous carbonaceous anode electrode coating, the anode electrode comprising:
an electrode substrate including a current collector; and
the porous carbonaceous anode electrode coating, including:
a surface material including graphite, wherein the surface material includes a plurality of sphere-shaped depressions;
carbon particles; and
a plurality of silicon particles affixed to inner walls of the plurality of sphere-shaped depressions, wherein the sphere-shaped depressions are configured for receiving expansion of the plurality of silicon particles when the silicon particles are in a lithiated state.

2. The anode electrode of claim 1, wherein each of the plurality of sphere-shaped depressions includes a portion of the plurality of silicon particles; and
wherein, when the plurality of silicon particles is in an unlithiated state, each of the plurality of sphere-shaped depressions includes an internal volume of at least three times the volume of the silicon particles in the unlithiated state.

3. The anode electrode of claim 1, wherein each of the plurality of silicon particles is permanently bonded to the inner walls of the plurality of sphere-shaped depressions, such that the plurality of silicon particles remains in conductive contact with the surface material through the lithiated state and the unlithiated state.

4. The anode electrode of claim 1, wherein the porous carbonaceous anode electrode coating is doped with nitrogen, phosphorus, silver, tin, lithium alloying materials, or conductive atoms to anchor the silicon to the surface material.

5. The anode electrode of claim 1, wherein, when the plurality of silicon particles is in the lithiated state, the anode electrode expands in volume in a range from 0% to 5% as compared to a volume of the anode electrode when the plurality of silicon particles are in the unlithiated state.

6. A battery cell including an anode electrode for use in a lithium-ion battery cell including silicon and a porous carbonaceous anode electrode coating, the battery cell comprising:
the anode electrode including:
an electrode substrate including a current collector; and
the porous carbonaceous anode electrode coating, including:
a surface material including graphite, wherein the surface material includes a plurality of sphere-shaped depressions;
carbon particles; and
a plurality of silicon particles affixed to inner walls of the plurality of sphere-shaped depressions, wherein the sphere-shaped depressions are configured for receiving expansion of the plurality of silicon particles when the silicon particles are in a lithiated state;
a cathode electrode; and
an electrolyte.

7. The battery cell of claim 6, wherein each of the plurality of sphere-shaped depressions includes a portion of the plurality of silicon particles; and
wherein, when the plurality of silicon particles is in an unlithiated state, each of the plurality of sphere-shaped depressions includes an internal volume of at least three times the volume of the silicon particles in the unlithiated state.

8. The battery cell of claim 6, wherein each of the plurality of silicon particles is permanently bonded to the inner walls of the plurality of sphere-shaped depressions, such that the plurality of silicon particles remains in conductive contact with the surface material through the lithiated state and the unlithiated state.

9. The battery cell of claim 6, wherein the porous carbonaceous anode electrode coating is doped with nitrogen, phosphorus, silver, tin, or lithium alloying atoms to anchor the silicon to the surface material.

10. A method to manufacture an anode electrode for use in a lithium-ion battery cell including silicon and a porous carbonaceous anode electrode coating, the method comprising:
affixing a plurality of silicon particles to each of a plurality of low temperature burnout particles configured for evaporating as a result of the burnout process;
creating a mixture including the plurality of low temperature burnout particles configured for evaporating as a result of a burnout process, each including the plurality of the silicon particles, a polymer material configured for creating electrically conductive graphite as a result of the burnout process, and carbon particles;
applying the mixture to an electrode substrate as a plurality of active material particles;
operating the burnout process upon the plurality of active material particles, wherein the burnout process:
converts the polymer material into the graphite to form an electrically conductive surface material of the plurality of active material particles;
vaporizes the plurality of low temperature burnout particles configured for evaporating as a result of the burnout process, thereby leaving a plurality of sphere-shaped depressions in the surface material, one of the plurality of sphere-shaped depressions for each of the plurality of low temperature burnout particles configured for evaporating as a result of the burnout process; and
results in the plurality of silicon particles being affixed to inner walls of the plurality of sphere-shaped depressions; and
wherein the sphere-shaped depressions are configured for receiving expansion of the plurality of silicon particles when the silicon particles are in a lithiated state.

11. The method of claim 10, wherein affixing the plurality of silicon particles to each of the plurality of low temperature burnout particles configured for evaporating as a result of the burnout process includes affixing the plurality of silicon particles to a plurality of polystyrene foam balls.

12. The method of claim 10, further comprising selecting the plurality of low temperature burnout particles configured for evaporating as a result of the burnout process in a size range configured such that a volume of the low temperature burnout particles configured for evaporating as a result of the burnout process is at least three times the volume of the silicon particles in an unlithiated state.

13. The method of claim 10, wherein affixing the plurality of silicon particles to each of the plurality of low temperature burnout particles configured for evaporating as a result of the burnout process includes rolling the plurality of low temperature burnout particles configured for evaporating as a result of the burnout process in a silicon dust.

14. The method of claim 10, wherein applying the mixture to the electrode substrate includes applying the mixture as a slurry.

15. The method of claim 10, wherein applying the mixture to the electrode substrate includes applying the mixture through an electrodepositing process.

16. The method of claim 10, wherein applying the mixture to the electrode substrate includes utilizing a vacuum drum device upon the electrode substrate to achieve a desirable dispersion of the active material particles upon the electrode substrate.

17. The method of claim 10, further comprising doping the mixture with nitrogen, phosphorus, silver, tin, lithium alloying materials, or conductive atoms to anchor the silicon particles to the inner walls.

18. The method of claim 10, further comprising adding to the mixture a binder, carbon black, or carbon nanotubes.
